(19) United States
(12) Patent Application Publication
(10) Pub. No.: US 2016/0101822 A1
(43) Pub. Date: Apr. 14, 2016

(54) Handle system carried on a Person

(71) Applicant: Pamela A. Schvey, Naples, FL (US)

(72) Inventor: Pamela A. Schvey, Naples, FL (US)

(21) Appl. No.: 14/509,089

(22) Filed: Oct. 8, 2014

(51) Int. Cl. B62J 27/00; A41F 9/00; A41F 15/00; B63C 9/11

(52) U.S. Cl. CPC B62J 27/00; B63C 9/11; A41F 9/005; A41F 15/00; B62J 2027/005

(57) ABSTRACT

The inventive concept is directed to hand-hold system applied to a driver of a conveyance device wherein the driver and the rider are moving on said device in a tandem fashion. Said hand-hold system includes a belt wherein the hand-holds are attached to the belt in several locations wherein at least two hand-holds are applied to a rear of the belt. Two more hand-holds each are applied to both sides of the driver. The hand-hold system can include a harness having shoulder straps passing over the shoulders of the driver. The hand-hold system may include a personal flotation device with the hand- holds being applied to the sides and the back of the flotation device. This arrangement assures that the driver is free of a personal contact with the rider and can perform the necessary functions in operating the functions of the conveyance.

### BACKGROUND OF THE INVENTION

The inventive concept is directed to a versatile hand-hold system. It is especially directed to a handle system worn by tandem riders moving on certain conveyance devices. Such conveyance devices could include wave-runners, jet skies, motor cycles, Vespa bikes, ATV's, snow-mobiles or even bicycles. The rider traveling behind the driver in a tandem fashion has to hang on to something to assure a safe ride. In most cases the tandem riders surround the driver with both arms to hang on. Any contact with the driver inconveniences the driver in his/her movements. Other hand-holds involve the tandem rider to insert or place his/her hands into the belt of the driver. If the driver wears a type of vest, the tandem rider would place his/her hands within the slanted pockets in the rear of the vest. It has been found that any physical contact with the driver of any conveyance devices encounters the desired movements of the driver in operating the conveyance device.

### BRIEF DESCRIPTION OF THE INVENTION

The inventive subject matter consists of a device incorporating hand-holds applied to a system which is worn by a driver involving a tandem conveyance including a driver and a rider located behind the driver. The hand-holds are constructed in a manner which will not encumber the driver in his/her necessary and proper movements. There are illustrated several embodiments of the hand-hold system.

### DETAILED DESCRIPTION OF THE INVENTION

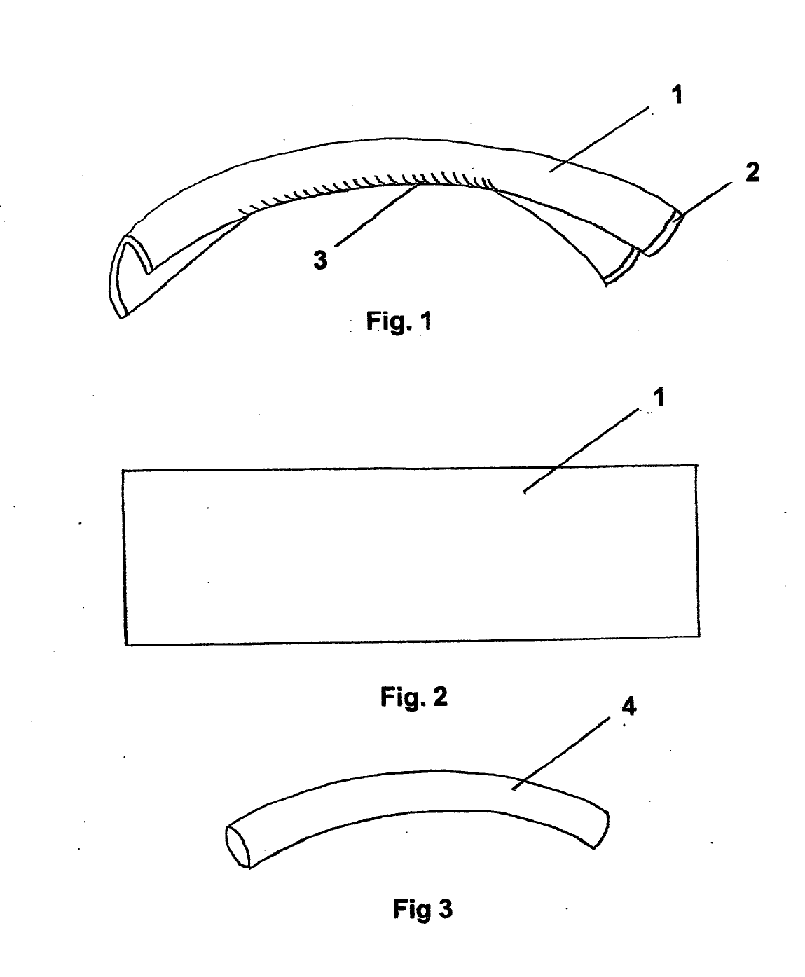

FIG. 1 illustrates a fortified hand-hold;

FIG. 2 shows a rectangular fabric type from which the fortified hand-hold is constructed;

FIG. 3 shows a plastic tubing which will be inserted into a fabric tube of FIG. 1;

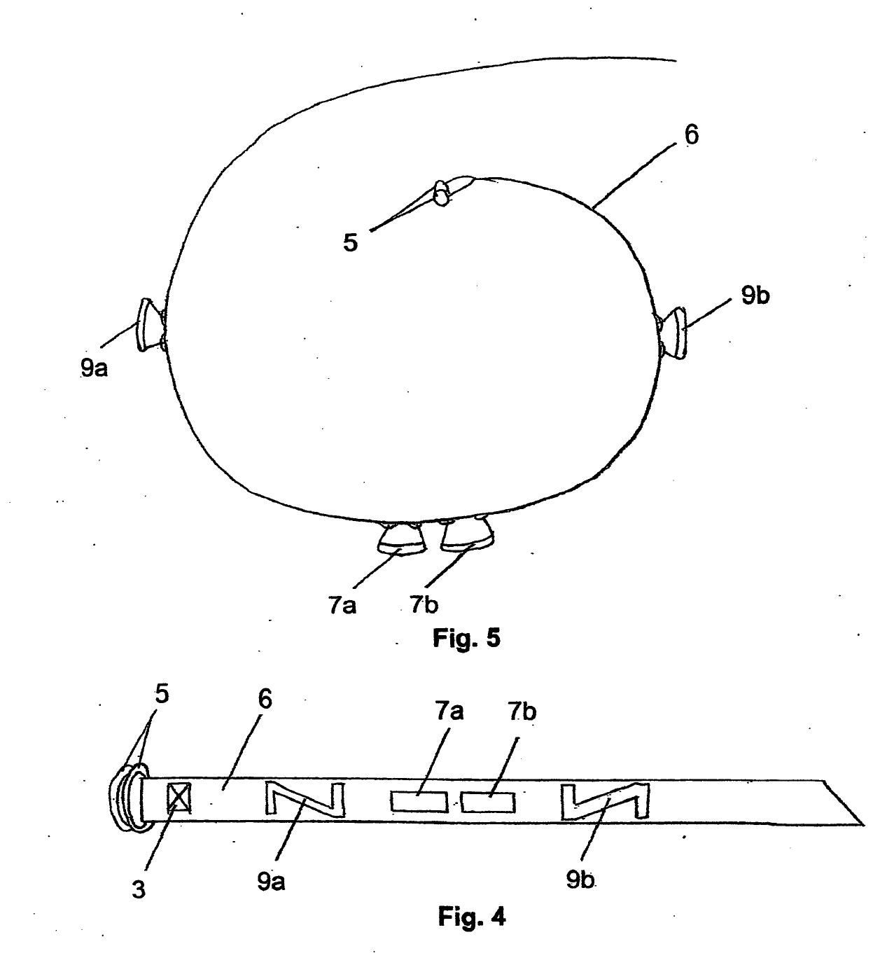

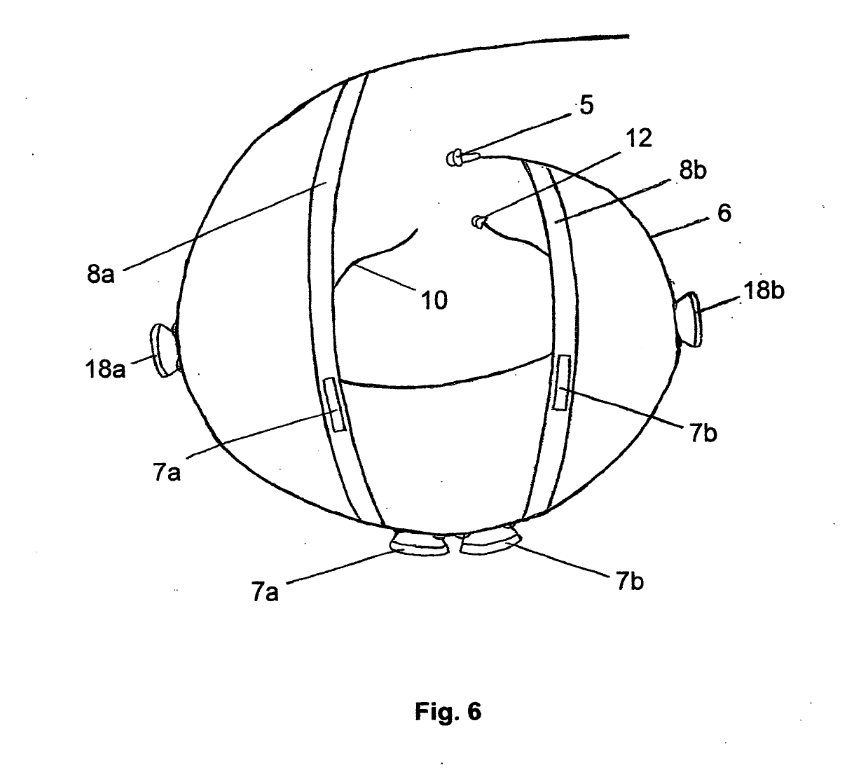

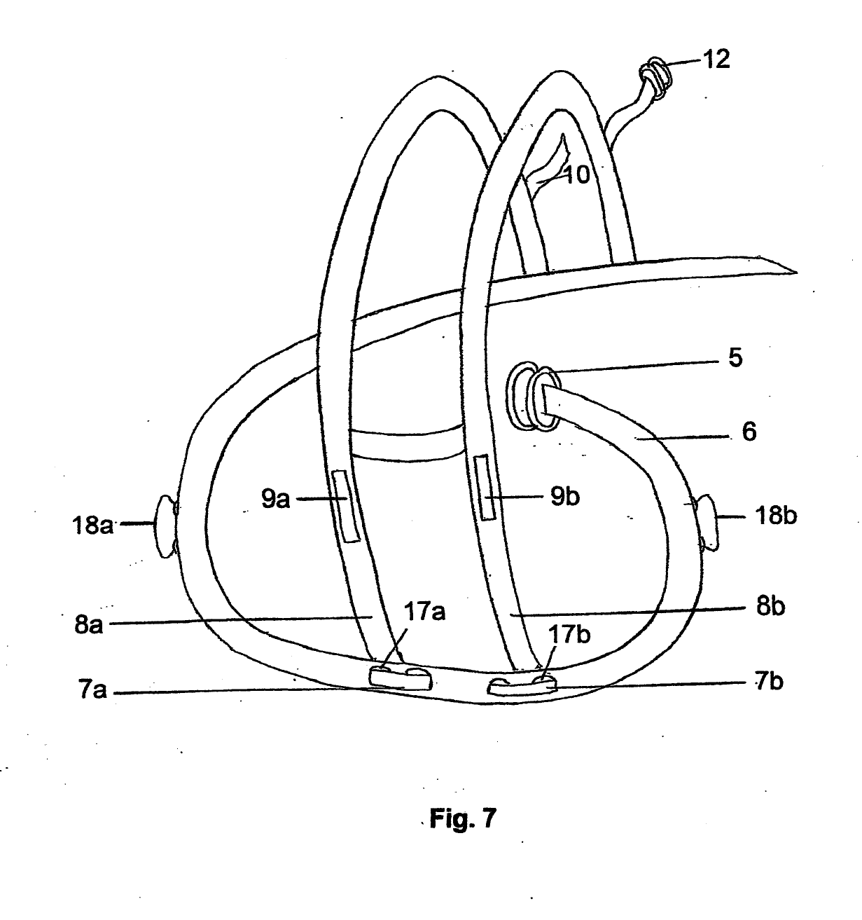

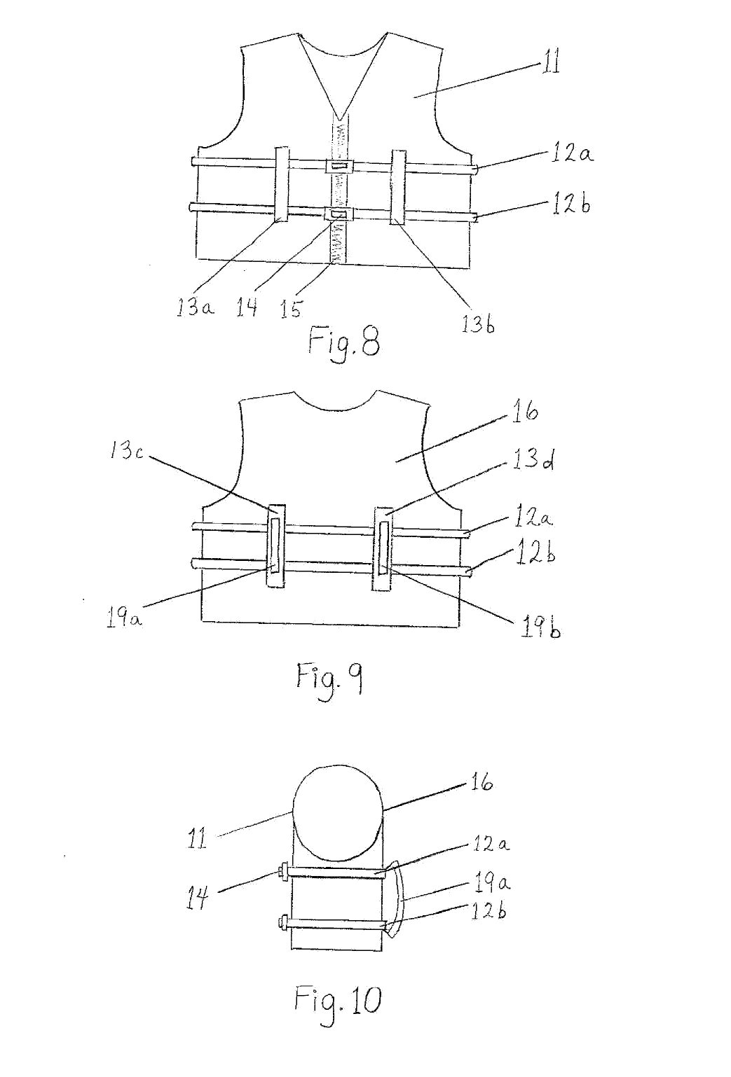

FIG. 4 illustrates a front view of a belt worn by the driver;

FIG. 5 is top view of the belt of FIG. 4;

FIG. 6 illustrates a harness worn around and over the shoulders of the driver;

FIG. 7 is a perspective view of the harness of FIG. 6;

FIG. 8 is a front view of a personal flotation device;

FIG. 9 is a rear view of the device of FIG. 8 having hand-holds thereon;

FIG. 10 is a side view of the device of FIG. 9.

Turning now to FIG. 1 which shows a regular tube which is constructed of a rectangular piece of fabric 1 of FIG. 2, wherein the longitudinal edges are joined to form a tube. The edges should be joined by a serging stitching as shown at 3. It is suggested that the material preferred is of a non-stretchable material to avoid any stretching while in use. The material could include polypropylene, polyester or polyarnide etc. The flaccid tube could be constructed as a non-woven. It is preferred that the thus constructed tube have a reinforcing plastic tube 4, (FIG. 3) placed therein. This will give the tandem rider an increase in confidence because he or she will have something solid in the hand instead of just flaccid material. The ends 2 of the tube 1 are left in a flaccid mode so that the hand-holds can be attached to any supporting system to be explained below. It should also be known that the material happens to be water resistent which prevents the hand-holds getting completely soaked. FIG. 4 illustrates a belt 6 of any construction having the fastening buckles 5 at either end. The rear of the buckle, as worn by the driver, has fastened thereto two hand-holds 7a and 7b. These hand-holds are formed in the manner as illustrated in FIGS. 1-3 The ends 2, FIG. 1. are left flaccid so that these ends may be attached to the belt 6 by either glue, Velcro, rivets, hook and eye or stitching. The two hand-holds 7a and 7b are placed in a parallel with the belt because the tandem rider, when grabbing the hand-holds at the rear side would encounter the hand-holds in a straight downward manner. If the hand-holds are used in a side mode of the driver, then the hand -holds 7 should be attached in a slanted manner as shown at 7a and 7b. The slanted placement improves the ability of the tandem rider to grasp the hand-hold because the arms and thereby the hands of the tandem rider approach the hand-holds placed on the sides of the belt in a slanted manner to thereby encounter the hand-holds in a correct manner and arm direction.

FIG. 5 is a top view of the belt system. The hand-holds in this FIG. appear in a curved manner. That is so because the ends 2 (FIG. 1) are attached to the belt at their end location. This aids the tandem rider to easily find the hand-holds.

FIG. 6 illustrates the hand-hold system incorporated into a harness worn by the driver of the conveyance. The harness consists of a belt 6 surrounding the driver including shoulder straps 8 depending over the shoulders of the driver. Hand-holds 7a and 7b are placed at the rear of the shoulder straps for the tandem rider to hang onto. The belt, surrounding the driver, is constructed in the same manner as was described above with reference to FIGS. 1-5. However, these FIGS. 6 and 7 include two over the shoulder straps 8a and 8b. The shoulder straps 8a and 8b are connected to the belt 6 and have hand-holds 9a and 9b. The belt 6 includes a chest strap 10 and buckle 12 to assure that the harness is stabilized on the torso of the driver of the conveyance. The shoulder straps are connected to the belt 6 by way of stitches 17a and 17b. FIGS. 6 and 7 also show the mounting of two hand-holds 17a and 17b attached to the belt 6. These hand-holds are placed at the rear of the belt 6. other hand-holds are shown at 18a and 18b and they are placed at the sides of the driver. These hand-holds have been discussed by making reference to FIG. 4.

FIGS. 8-10 illustrate yet another hand-hold system. This system includes a personal flotation device or a swim vest 11. This may be an important feature when riding any wave runners. FIG. 8 shows the front of the swim vest including two straps 12a and 12b. The front of the swim vest is being closed by a zipper 15. The two strap loops 19a and 19b have attached thereto hand-holds 13a and 13b. FIG. 9 shows a rear view of the swim vest 16. The same call out numbers have been assigned to this FIG. 9. FIG. 10 shows a side view of the personal flotation device 16 or with other words a swim vest 16. Again the same numbers have been assigned to this illustration.

What I claim is:

1. A hand-hold system carried by a driver of a conveyance, said conveyance using a driver and a rider in a tandem manner, the hand-hold system includes a belt worn by said driver around the waist, hand-holds are attached to said belt, two hand-holds are applied to said belt, and two of the hand-holds are applied to the back of the driver, two other hand holds are applied to the sides of said belt, said other hand-holds are applied in a slanted position to accommodate the hands of said rider wherein the arms including the hands of said rider are moving in the correct slanted direction.

2. The hand-hold system of claim 1, wherein said hand-holds are constructed of a fabric material in a tubular manner, a plastic tube is inserted into said tubular fabric material as a reinforcement.

3. The hand-hold system of claim 1 including harness straps placed over the shoulders of said driver.

4. The hand-hold system of claim 3, wherein hand-holds are attached to said harness straps at a rear location relative to said driver.

5. The hand-hold system of claim 3, wherein Hand-holds are attached at the sides of said driver.

6. The hand-hold system of claim 1, wherein said hand-holds are applied to a personal flotation device.

7. The hand-hold device of claim 6, wherein said hand-holds are applied to a rear surface of said flotation device.

8. The hand-hold device of claim 6, wherein said hand-holds are applied at each side of said flotation device.
